(19) United States
(12) Patent Application Publication
(10) Pub. No.: US 2016/0259942 A1
(43) Pub. Date: Sep. 8, 2016

(54) AUTOMATIC PROFILING FRAMEWORK OF CROSS-VM COVERT CHANNEL CAPACITY

(71) Applicant: INTELLECTUAL VENTURES HONG KONG LIMITED, Central, Hong Kong (CN)

(72) Inventors: Jianping Wang, Kowloon Tong (HK); Rui Zhang, Kowloon Tong (HK); Wen Qi, Kowloon Tong (HK)

(21) Appl. No.: 14/761,544

(22) PCT Filed: Oct. 21, 2014
(86) PCT No.: PCT/CN2014/089008

§ 371 Date: Jul. 16, 2015

(51) Int. Cl. G06F 21/57; G06N 7/00; G06F 9/455

(52) U.S. Cl. CPC G06F 21/577; G06F 9/45558; G06N 7/005; G06F 2009/45587; G06F 2221/034

(57) ABSTRACT

Technologies are generally described for a framework to automatically estimate cross-VM covert channel rapacity for channels such as central processing unit (CPU) load, CPU L2 cache, memory bus and disk bus. In some examples, the framework may include automated parameter tuning for various cross-VM covert channels to achieve high data rate and automated capacity estimation of those cross-VM covert channels through machine learning. Shannon Entropy formulation may be applied to estimate the capacity of cross-VM covert channels established on any given cloud platform. Furthermore, the noise of a cross-VM covert channel under a specific cloud platform may be statistically modeled to eliminate the covert channel implementations which perform poorly, thereby narrowing the parameter space. A number of sample signals may be collected with their corresponding ground truth labels, and machine learning tools may be utilized to cross-validate the samples and estimate the capacity of the covert channels.

### BACKGROUND

Unless otherwise indicated herein, the materials described in this section are not prior art to the claims in this application and are not admitted to be prior art by inclusion in this section.

Cross-virtual machine (VM) covert channels leverage on the shared physical components between the virtual machines co-residing on a physical machine to breach their logical isolation. This security flaw may lead to information leakage on public clouds because virtual machines of distinct tenants may be allowed to co-reside with each other. Different implementations or hardware/software environments may result in different covert channel capacities. Security measures that attempt to mitigate cross-VM covert channel attacks may not be success fill without knowledge of covert channel capacity on a particular public cloud.

### SUMMARY

The present disclosure generally describes techniques related to automatic profiling of cross-VM covert channel capacity.

According to some examples, methods to profile cross-VM covert channel capacity are described. An example method may include collecting received signals at a receiver side for each pattern of symbols at a sender side; determining classification boundaries for the collected signals; determining probabilities of occurrence for a predefined symbol within each pattern of symbols in sent signals and the collected signals based on the classification boundaries; iteratively determining an optimal probability of occurrence for the predefined symbol within each pattern of symbols to be received by an attacker based on the probabilities of occurrence; and determining an upper boundary for the cross-VM channel capacity based on the optimal probability of occurrence.

According to other examples, a server configured to profile cross-VM covert channel capacity is described. The server may include a communication module configured to communicate with a plurality of virtual machines executed on one or more servers and a processor communicatively coupled to the communication module. The processor may be configured to collect received signals at a receiver side for each pattern of symbols at a sender side; determine classification boundaries for the collected signals; determine probabilities of occurrence for a predefined symbol within each pattern of symbols in sent signals and the collected signals based on the classification boundaries; iteratively determine an optimal probability of occurrence for the predefined symbol within each pattern of symbols to be received by an attacker based on the probabilities of occurrence; and determine an upper boundary for the cross-VM channel capacity based on the optimal probability of occurrence.

According to further examples, methods to profile cross-VM covert channel capacity are described. An example method may include modelling a noise level of a cross-VM covert channel between two co-resident virtual machines (VMs) established in a cloud platform; generating sample signals employing one or more distinct timing parameter settings of the cross-VM covert channel; modifying the generated sample signals by adding noise based on the modelled noise level; arranging far the modified sample signals to be transmitted by one of the co-resident VMs and collected by the other of the co-resident VMs; analyzing the collected sample signals by iteratively determining an optimal probability of occurrence for a predefined symbol within each sample signal; and determining an upper boundary for the cross-VM channel capacity based on the optimal probability of occurrence,

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will he described with additional specificity and detail through use of the accompanying drawings, in which:

FIG. 1 illustrates an example architecture of a framework for profiling of cross-VM covert channel capacity;

FIG. 2 illustrates an example threat model co-resident VM attacks in an infrastructure as a service (IaaS) cloud;

FIG. 3 conceptually illustrates an example cross-VM covert channel attack;

FIG. 4 illustrates three stages of an example automatic profiling framework for cross-VM covert channel capacity;

FIG. 5 illustrates an example clustering of data points in the sampling stage of an example automatic profiling framework for cross-VM covert channel capacity;

FIG. 6 illustrates a general purpose computing device, which may be used to provide an example automatic profiling framework for cross-VM covert channel capacity,

FIG. 7 is as flow diagram illustrating an example process to profile cross-VM covert channel capacity that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may he used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to automatic profiling of cross VM covert channel capacity.

Briefly stated, technologies are generally described for a framework suitable to automatically estimate cross-VM covert channel capacity for channels such as central processing unit (CPU) load, CPU L2 cache, memory bus, disk bus, and the like. In some examples, the framework may include automated parameter tuning for various cross-VM covert channels to achieve high data rate and automated capacity estimation of those cross-VM covert channels through machine learning. Shannon Entropy formulation may be applied to estimate the capacity of cross-VM covert channels established on any given cloud platform. Furthermore, the noise of a cross-VM covert channel under a specific cloud platform may be statistically modeled to eliminate the covert channel implementations which perform poorly, thereby narrowing the parameter space. A number of sample signals may be collected with their corresponding ground truth labels, and machine learning tools may be utilized to cross-validate the samples and estimate the capacity of the covert channels.

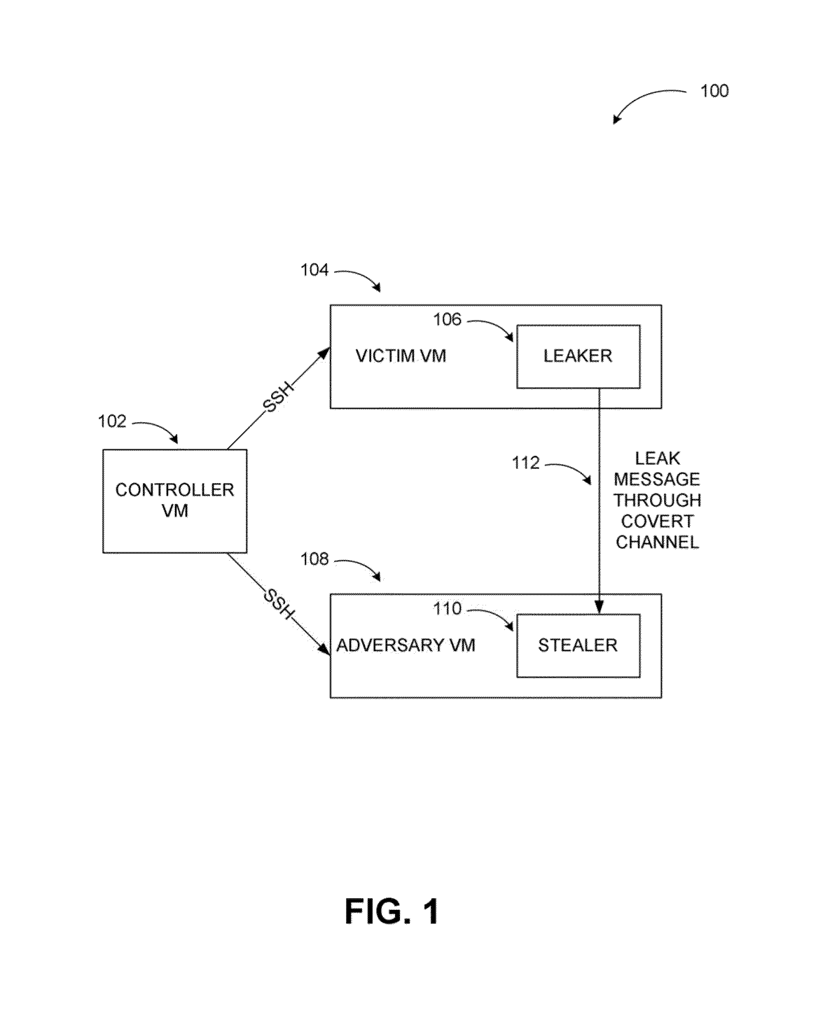

FIG. 1 illustrates an example architecture of a framework for profiling of cross-VM covert channel capacity, arranged in accordance with at least some embodiments described herein.

Cross-VM covert channels may be established between two virtual machines (VMs) that co-reside on the same physical machine. If both VMs share a physical component of the machine, the usage by one VM may unexpectedly affect the usage of the other VM. Covert channels can be established by intentional contention and contention detection on the shared physical components between two co-resident VMs. Covert channels may be categorized in timing-based covert channels and storage-based covert channels, however, a majority of cross-VM covert channels are timing-based channels.

A timing-based channel may be constructed as follows. The sender may encode data by varying the time required for performing an operation whose execution time is sensitive to the contention from other co-resident VMs. The receiver may monitor the system status by frequently performing the operation and measuring the execution time. For example, the receiver may divide its time into equal sized sampling periods. For each sampling period, the receiver may repeatedly execute the contention sensitive operation and count the number of times the operation is executed. The sender may divide its time into much longer equal sized intervals. In each interval, the sender may attempt to transmit one data bit. To transmit a bit “1”, the sender may pose contention to the operation by repeatedly executing the operation. To transmit a bit “0”, the sender may stay idle.

While four types of cross-VM covert channels are typically referenced in practical implementations, other types may also be employed. The four types may include L2 cache covert channel, which may use the access to central processing unit (CPU) L2 cache as the contention sensitive operation for establishing the covert channel; CPU load covert channel, which may be established between VMs sharing CPU cores; memory bus covert channel, which may utilize memory bus lock as the contention sensitive operation; and disk bus covert channel, which may utilize reading and writing to the disk as the contention sensitive operation.

As shown in a diagram 100, three actors may be defined in a profiling framework according to embodiments. The actors may include a controller VM 102, a leaker 106 residing in a victim VM 104, and a stealer 110 residing in an adversary VM 108. Initially, the binary files of the leaker 106 and the stealer 10 may be prepared by the controller VM 102. The controller VM 102 may then transmit or provide the binary files to the victim VM 104 and the adversary VM 108 via secure copy (SCP) communication. Next, the controller VM 102 may invoke (i.e., activate) the leaker 106 and the stealer 110 via secure shell (SSH) communication. Upon activation of the leaker 106 and the stealer 110, the sampling process may start. The stealer 110 may collect sampling results on the leaked message 112 through the covert channel, which may be retrieved by the controller VM 102 via SCP.

An automatic profiling framework to estimate the transmission capacity of cross-VM covert channels according to embodiments may include parameter tuning for optimization of the covert channel and machine learning for evaluation of the covert channel's maximum capacity. The Shannon Entropy formulation may be applied to estimate the capacity of cross-VM covert channels established on any given cloud platform. The noise of a cross-VM covert channel under a specific cloud platform may be statistically modeled to eliminate the covert channel implementations which perform poorly. Thus, the parameter space may be narrowed through the statistical modeling. Using fined-tuned covert channel implementations, a number of sample signals may be collected with their corresponding ground truth labels. Machine learning tools may be utilized to cross-validate the samples and to estimate the capacity of the covert channel. For example, as duration for posing contention to the memory bus for establishing memory bus covert channels and a proportion of cache to be evicted for establishing CPU L2 cache covert channels may be fine-tuned.

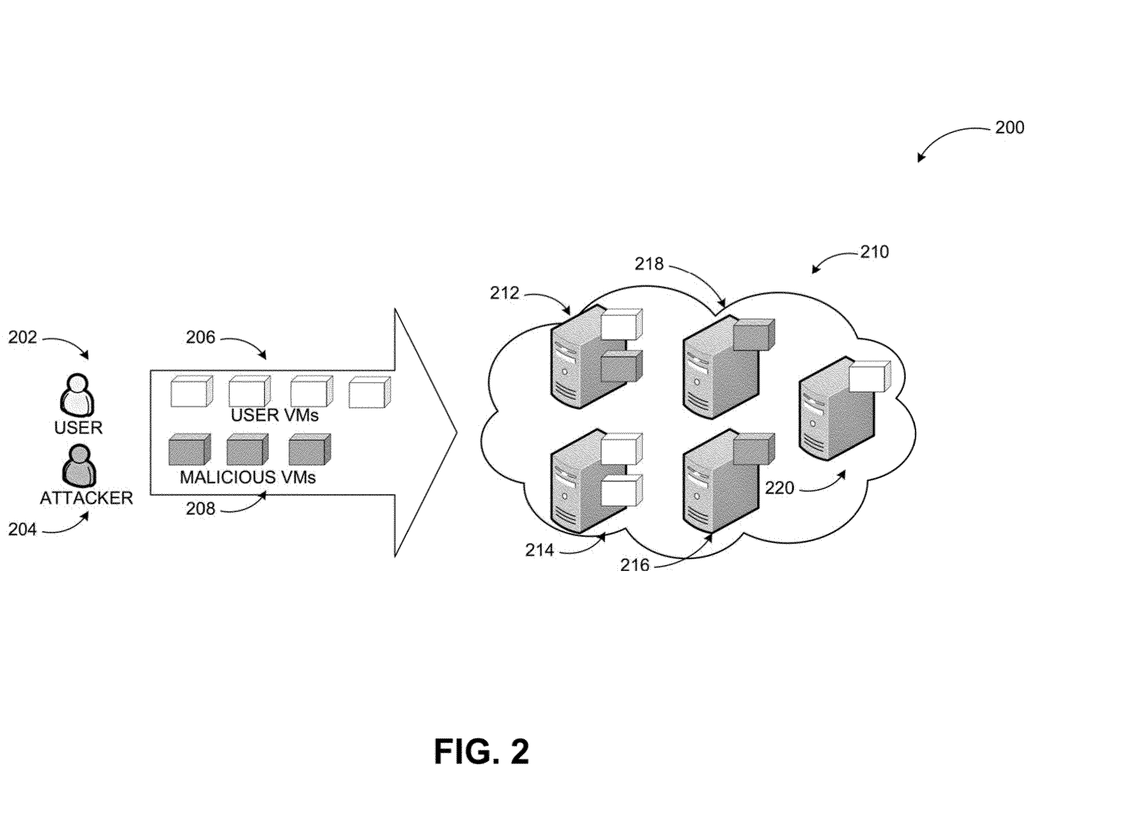

FIG. 2 illustrates an example threat model for co-resident VM attacks in an infrastructure as a service (IaaS) cloud, arranged in accordance with at least some embodiments described herein.

Two strategies may be used to establish information leakage between co-resident virtual machines, covert channels and side channels. Side channels may attempt to recognize the side effects of co-resident VM workload such as CPU performance degradation or CPU cache eviction and to infer sensitive information of the co-resident VM. Covert channels may rely on compromising the co-resident VM, e.g., implanting a Trojan horse program, before information leakage can be established. The compromised VM (or implanted Trojan horse) may actively retrieve confidential data stored and cast them out through unexpected channels, such as deliberate contention and idle on a shared physical component of the physical machine. Thus, other co-resident VMs may be able to decode the data by monitoring such unexpected channel. Both strategies involve VM co-residency.

While both side channel and covert channel may pose security problems, covert channel leakage may typically be considered to be more of a concern in cloud-based systems. Moreover, covert channel may use unexpected communication methods, which may be hard to detect and may survive a long time causing more severe information leakage. Covert channel leakage may also pass through firewall is and similar security measures because the established information flow may be unexpected and uncontrolled. The cooperation between the victim VM and the adversary co-resident VM may also increase the odds of success in establishing information leakage.

Cross-VM covert channel may be specifically harmful in a public cloud, because the attacker may be a legitimate user of the public cloud. Actions performed by the attacker to launch a covert channel attack may be seemingly benign to the cloud provider. Therefore, it may be difficult to prevent cross-VM covert channel attacks through a policing approach.

As shown in a diagram 300, VMs in a cloud 210 may be categorize as user VMs 206 and malicious VMs 208. A user 202 (a potential victim, not an attacker) may launch the user VMs 206, while the malicious VMs 208 may be launched by an attacker 204. The user VMs 206 and the malicious VMs 208 may be distributed to various physical machines at the cloud 210. For example, a server 214 and a server 220 may host only user VMs while servers 216 and 218 may host only malicious VMs. Yet, a physical server 212 may host both a user VM and an attacker VM providing a suitable environment for cross-VM covert channel leakage.

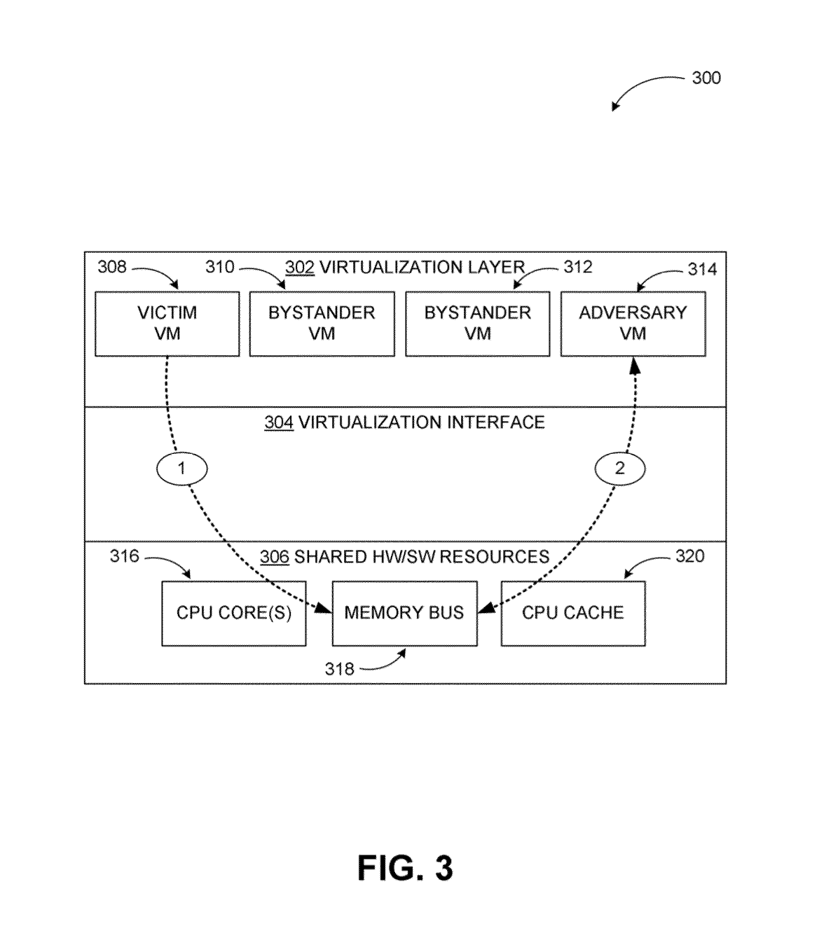

FIG. 3 conceptually illustrates an example cross-VM covert channel attack, arranged in accordance with at least some embodiments described herein.

As shown in a diagram 300, cross-VM covert channels may he established as follows. One or more software/hardware resources 306 may be shared between an adversary VM 314 and a victim VM 308, along with bystanders VMs 310 and 312, all residing at a virtualization layer 302. The victim VM 308 and the adversary VM 314 may be able to issue requests to the software/hardware resources 306. The victim VM 308 may cause contention on the software/hardware resources 306 by issuing intense job requests (1) through a virtualization interface 304. Then, the adversary VM 314 may be able to detect the contention on the software/hardware resources 306 by issuing frequent job requests (2) to the sotware/hardware resources 306 through the virtualization interface 304 and measuring execution time of each request. Information stored within the victim VM 308 may be encoded in the form of a binary string of “1”s (contention) and “0”s (not contention) to be decoded by the adversary VM 314. The decoding of the victim VM encoded information may also be referred to as the timing channels. The shared software/hardware component 306, which may be used to establish such covert channels may include CPU core(s) 316, CPU (L2) cache 320, and memory bus 318 prone to such covert channels.

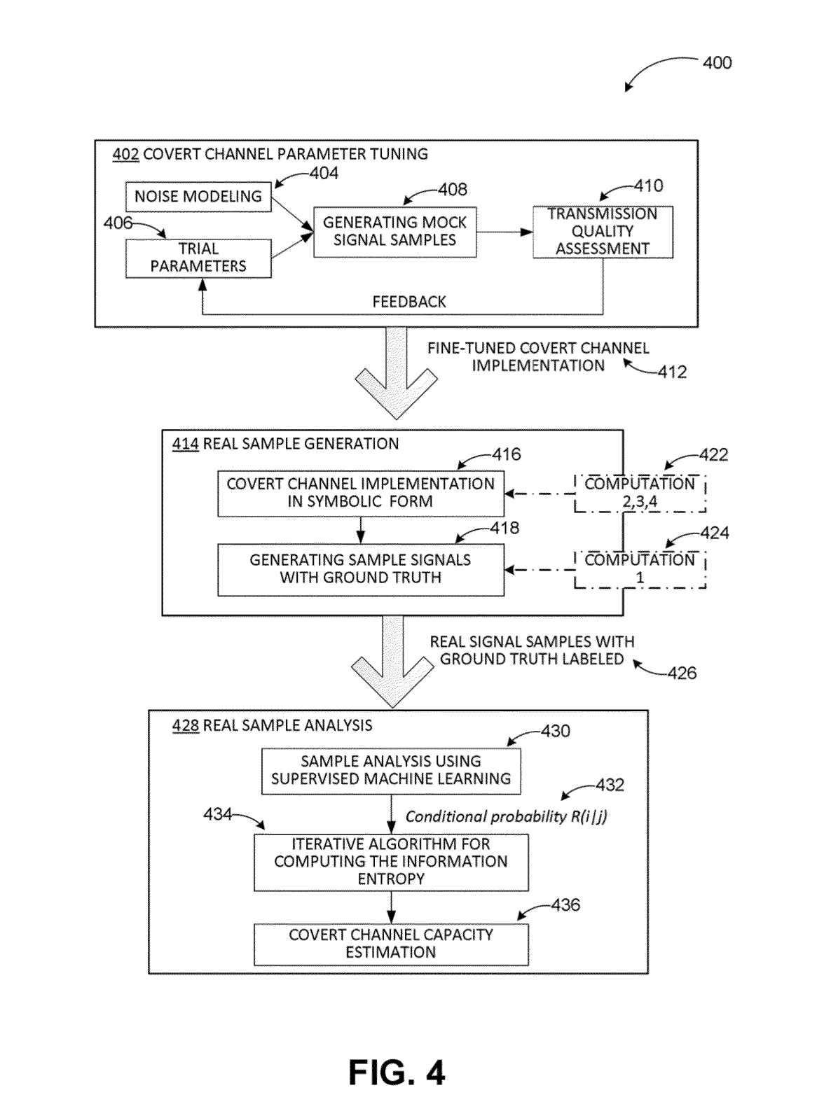

FIG. 4 illustrates three stages of an example automatic profiling framework for cross-VM covert channel capacity, arranged in accordance with at least some embodiments described herein.

As shown in a diagram 400, automatic profiling of cross-VM covert channel capacity may be performed in three main stages: a covert channel parameter tuning stage 402, a real sample generation stage 414, and a real sample analysis stage 428. Embodiments are not limited to the example three stages. Automatic profiling of cross-VM covert channel capacity may also be performed with additional or fewer stages, where some operations may be moved between stages, new operations added, or some operations eliminated depending on the specific circumstances.

The covert channel parameter tuning stage 402 may include a generation of mock signal samples process 408 with input from a noise modeling process 404 and trial parameters 406. The generated mock samples may be used in a transmission quality assessment process 410, which may provide feedback to the trial parameters 406. An output of the covert channel parameter tuning stage 402 may be fine-tuned covert channel implementation 412 that is provided to the real sample generation stage 414. The real sample generation stage 414 may include a covert channel implementation in symbolic form 416 using computations 2, 3, and 4 described herein. The real sample generation stage 414 may also include generation of sample signals with la ground truth 418 using computation 424 described herein. An output of the real sample generation stage 414 may be real signal samples with ground truth labeled 426, which may be provided to the real sample analysis stage 428.

At the real sample analysis stage 428, a sample analysis 430 may be performed using supervised machine learning (e.g., neural networks) providing as a result conditional probability R(i|j) 432 to an iterative computation 434 to determine information entropy (Shannon's Entropy formulation). A result of the iterative computation 434 may be used in covert channel capacity estimation 436 by determining upper boundaries for the channel based on the optimal probability of occurrence qⱼ for symbol j in the sequence or symbols cast out by the sender.

An example implementation scenario of automatic profiling of cross-VM covert channel capacity estimation may involve three entities, a sender, a receiver, and a controller. The sender and the receiver may be a pair of VMs co-residing on the same physical machine provided by the cloud service provider and representing the victim and the attacker, respectively. The controller may he executed on a separate machine or on the same machine. The controller may directly communicate with bath the sender and the receiver, for example, through SSH.

As discussed above, the profiling process may be decomposed into three stages. Initially, executable files may be transmitted from the controller to the sender and the receiver. For the parameter tuning stage, the sender and the receiver may cooperate on collecting samples for measuring noise model parameters. The samples may be statistically analyzed at the receiver side. Then, the parameterized noise model may be sent back to the controller. The controller may enumerate a large amount of covert channel parameter settings and filter out those which may perform poorly on the given noise model. The selected parameter settings may be sent to the receiver and the sender to reconfigure the covert channel implementation. The receiver and the sender run collect samples of the alphabet symbols at the sample collection stage. The collected samples may be transmitted back to the controller to compute a final capacity estimation. Following pseudo codes are example computations for the sender (Computation 1), the receiver (Computation 2), and the controller (Computation 3).

### Computation 1:

| | |
|---|---|
| 1: | tcp_connect(receiver) |
| 2: | tcp_transmit(start signal) |
| 3: | for all alphabet ε alphabetsets do |
| 4: | for i = 1 to N do |
| 5: | for all binary value ε alphabet do |
| 6: | if binary value = 0 then |
| 7: | idle(dₛ) |
| 8: | else |
| 9: | contention(dₛ) |
| 10: | end if |
| 11: | end for |
| 12: | Transmit the delimiter. |
| 13: | end for |
| 14: | end for |
| 15: | tcp_trasmit(ending signal) |

### Computation 2:

| | |
|---|---|
| 1: | listen(tcp port) |
| 2: | repeat |
| 3: | idle( ) |
| 4: | until Receive the start signal from the sender, |
| 5: | repeat |
| 6: | sampling data = contentiom(period dᵣ) |
| 7: | write_file(sampling data) |
| 8: | until receive the ending signal |

### Computation 3:

| | |
|---|---|
| 1: | transmit(receiver binaries, receiver VM) // via SCP. |
| 2: | transmit(sender binaries, sender VM) //via SCP. |
| 3: | launch(receiver) // via SSH. |
| 4: | launch(sender) // via SSH. |
| 5: | repeat |
| 6: | idle( ) |
| 7: | until the receiver finishes profiling. |
| 8: | retrieve(sampling data, receiver VM) // via SCP. |
| 9: | delimiters = detect delimiters(sampling data) |
| 10: | segments = split(sampling data, delimiters) |
| 11: | for all segtnent ε segments do |
| 12: | customized hieratical clustering(segment) // see Algorithm 1 |
| 13: | end for |
| 14: | Process the sampling data with neural network classifier |

At the parameter tuning stage, the noise of cross-VM covert channels established in any particular cloud platform may be modeled in order to harrow down the parameter space. Based on the noise model, sample signals may be generated under different parameter settings of the cross-VM covert channel. In some example implementations, three configurable parameters may be used for the timing based cross-VM covert channels. Threshold t₀ may be used for distinguishing between the high and low signal value; the interval for sending one data bit from the sender may be denoted as dₛ; and the interval of one sampling period at the receiver may be denoted as dᵣ. Given a specific parameter setting for a covert channel, mock samples may be generated by adding noise based on the model to the ground truth signals. Subsequently, the sample signals may be statistically analyzed with respect to their ground truth and the covert channel setting may be assessed.

The parameter tuning process may be iterated for different covert channel implementations. The settings which may lead to as large covert channel capacity may be collected and used in further profiling processes. As generating the mock signal samples may take comparatively less time in comparison to collection of real samples, a number trials may be performed and an overview of the parameter space obtained.

For discrete parameters, such as the encoding technique used by the covert channel, the noise may be separated into two parts, the system background noise and the front-end noise caused by user applications. The front-end noise may be unstable as the users may execute different applications at different time instances. The background noise is generally stable and may be modeled statistically. These two types of noise combined together may form the noise of cross-VM covert channels. By modelling the system background noise, an initial parameter space reduction may be performed for the covert channel implementation. The front-end noise may be reduced by, for example, silencing user induced workloads on the machine.

For sample collection, a covert channel may be established on two co-resident VMs under the test environment with the corresponding parameters, and the signals exchanged between the sender and the receiver through the cross-VM covert channel may be treated as symbols. A signal alphabet may be generated and for each symbol in the alphabet, a number of signal samples may need to be collected from the receiver side in order to apply statistical analysis. In some cases, a boundary between signal samples may not be reliably received by the receiver. The separation of signal samples may be achieved by pre-processing such as hierarchical clustering as discussed below in conjunction with 5.

A sequence of binaries may be grouped as one compact symbol in order to make the symbol losses and insertions insignificant to the capacity estimation. The binaries may be denoted as ‘0β” and “1β”. For a frame size, m, (a configurable integer which is greater than 1), each symbol in the covert channel alphabet may be composed of m binaries. The alphabet may have 2^{m} distinct symbols. For example, when m=2, the alphabet may be {“00”, “10”, “01”, “11”}.

As discussed above, the channel noise may cause variation of the duration for transmitting a data bit during the transmission of data symbols. This variation may accumulate as more points are sampled. Eventually, a bit insertion or loss error may occur. Delimiters may be used to constrain the propagation of shined boundaries. The delimiters may be produced by the sender frequently alternating between contention and idle to the contention sensitive operation. The receiver may detect the delimiter by monitoring the difference between consecutive sampling values. If the accumulated difference exceeds a predefined threshold, the receiver may infer a current signal to be a delimiter. To find the end of the delimiter, the same process may be performed except that, if the accumulated difference tails below a predefined threshold, the receiver may infer the current signal as the end of the delimiter. Using different delimiter size may result in a perform-accuracy trade-off for the covert channel. Increasing the delimiter site may improve the transmission accuracy while reducing the transmission speed. Decreasing delimiter size may increase the transmission speed while reducing the transmission accuracy. Thus, a configurable parameter to the covert channel implementation may be used to determine the delimiter size used.

For each symbol in the alphabet, N copies of the symbol may be transmitted through the covert channel, consecutively, with delimiters inserted in between. A variety of sample sets may be generated with different transmission frequency, B. Thus, a range of capacity estimations and a confidence interval on the maximum capacity estimation may be obtained.

As mentioned previously, sample analysis may be based on Shannon Entropy formulation. The Shannon equation is often used to estimate the capacity of communication channels:

C=B log₂(1+SNR), [1]

where, C represents the channel capacity, B stands for the bandwidth and SNR is the signal-to-noise ratio of the communication channel.

To avoid complications with having to compute SNR, a Shannon Entropy based approach may be employed, where the covert channel capacity, C, may be computed as:

$$𝒞 = B {max}_{{q}_{j} , j = 1 …N} ( Σ {q}_{j} R ( i \vert j ) log ( \frac{R ( i \vert j )}{{Σ}_{{j}^{′} , {j}^{′} = 1 …N} {q}_{{j}^{′}} R ( i \vert {j}^{′} )} ) ) , \qquad [ 2 ]$$

where R(i|j) denotes the conditional probability that the receiver received symbol i given the fact that the sender transmitted symbol j and qⱼ, j=1 . . . N, is the probability of occurrence for symbol j in the sequence of symbols cast out by the sender with the symbol alphabet having a total of N distinct symbols.

The decisive variables of equation [2] are R(i|j) as the value of qⱼ which maximizes C may be determined based on R(i|j) using an iterative technique as discussed below. According to equation [2], the conditional probability, R(i|j), may be computed for estimating the covert channel capacity. Following application of a customized hierarchical clustering to pre-process the samples, a neural network classifier may be used to cross-validate the real samples and compute R(i|j) for the classification result in some examples.

The iterative technique to compute the maximum covert channel capacity may be repeated for each covert channel implementation collected from the parameter tuning stage. The confidence interval for the capacity of the covert channel settings may also be reported along with the capacity information. After obtaining the conditional probability. R(i|j) from the classifier, the optimal prior probability of occurrence q={qⱼ}_{j=1 . . . N} distribution for the sender symbols may be iteratively computed. To distinguish between the prior probability of occurrence distribution vector q computed on different interactions, the prior probability of occurrence distribution obtained on the t^{th} iteration may be denoted as q^{t}={qⱼ^{t}}_{j=1 . . . N}. The iteration may begin with setting the initial prior probability of occurrence, q₀, to be

$${q}_{j}^{0} = \frac{1}{N}$$

for all=1 . . . N. Then, the following two steps may be iterated until the vector difference between q^{t} and q^{t+1} is smaller than a predefined threshold (for example, 0.0001).

### 1) Define φ^{t} as:

$${ϕ}^{t} ( j \vert i ) = \frac{R ( i \vert j ) {q}_{j}^{t}}{{\sum }_{k = 1}^{N} R ( i \vert k ) {q}_{k}^{t}} \qquad [ 3 ]$$

2) Update q using the following equation and normalize q by dividing each element with the sum of all elements:

qⱼ^{t+1}=exp(Σᵢ₌₁^{N}R(i|j)log(φ_{j|l}^{t})). [4]

Due to the logarithmic computation in the second step, all elements of R may need to be positive, to avoid a divergence. To address that potential challenge, a small number such as 1E-6 may be added to each entry of R. Once q₁ is computed, equation [2] may be used to determine the upper boundary for the covert Channel capacity.

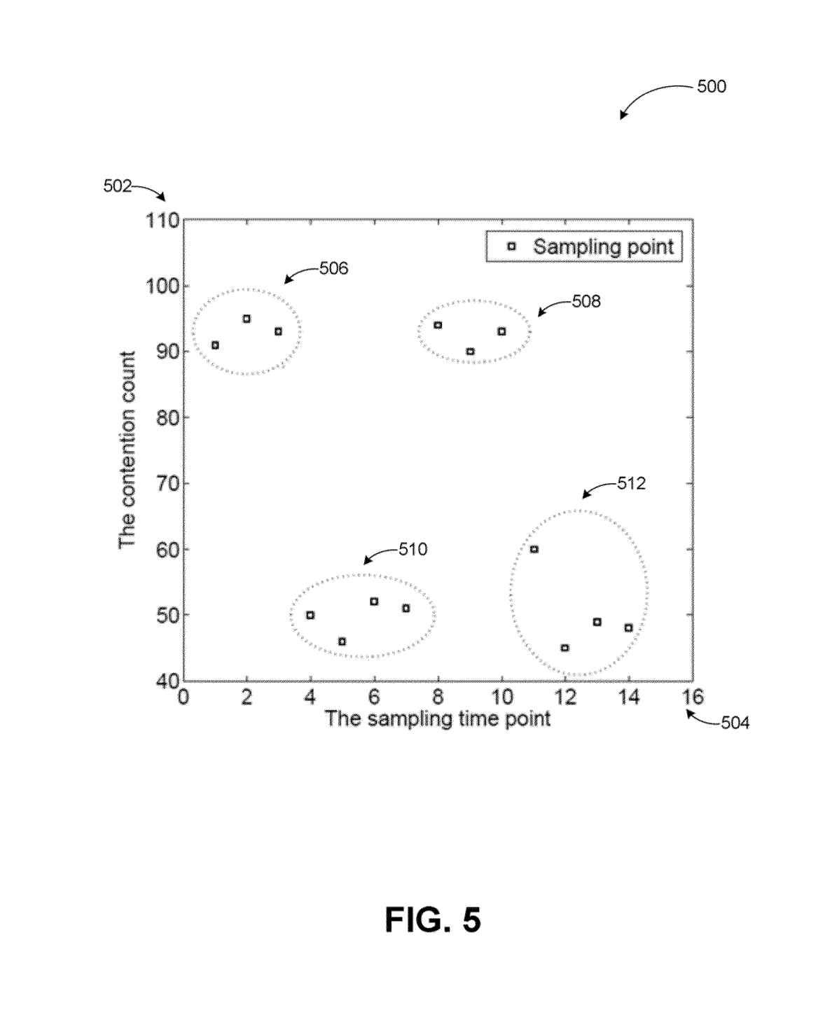

FIG. 5 illustrates an example clustering of data points in the sampling stage of an example automatic profiling framework for cross-VM covert channel capacity, arranged in accordance with at least some embodiments described herein.

During, transmission of information between a sender (victim) and a receiver (adversary), bit loss/insertion and bit-flip may directly affect the transmission accuracy. As discussed previously, a duration for transmitting one data bit may be defined as dₛ and a duration for one sampling period may be defined as dᵣ, where dₛ>dᵣ. The receiver may receive multiple readings for a single bit, which may empirically improve the transmission accuracy. An adjustable parameter n may be introduced so that dₛ=n×dᵣ. Thus, n sampling points may be obtained for a single data hit. If n is small, for example, n=1, the receiver may be expected to experience a high data loss or error rate. On the other hand, a large n may limit a maximum value of the sample. In an extreme case, the samples may be either one or zero which may also reduce the transmission accuracy.

In some examples, a controller performing the profiling of the cross-VM covert channel may ensure the samples are of the same dimension before passing the samples to machine learning tools. To achieve that, a customized hierarchical clustering approach may be employed. The input parameters to the clustering computation may be a set of signal samples S and a number of target clusters, k, where, k may also represent the dimension of the samples after being processed by hierarchical clustering.

In a diagram 500, clustering of the samples is illustrated across a sampling time point axes 504 and a contention count axis 502. For the example scenario or the diagram 500, a sender max transmit example data 0101 and a receiver may receive with four sampling points (n=4). Two sampling points may be lost in a first sampling group 506 and a third sampling group 508. For dimension of samples, k=4, sampling points may be clustered in four groups 506, 508, 510, and 512 after being processed by the customized hierarchical clustering computation ensuring samples are grouped based on similar dimensions. Following is an example computation (Computation 4) for hierarchical clustering:

| | |
|---|---|
| 1: | C = build_cluster_list(S) |
| 2: | while C.size > k and no cluster contains single point do |
| 3: | D = init_distance_list( ) |
| 4: | for all cluster c ε {x ε C, x 6= C.last} do |
| 5: | D.add(distance(c, c.next)) |
| 6: | end for |
| 7: | for all cluster c ε {x ε C, x 6= C.last} do |
| 8: | if distance(c, c.next) = D.min then |
| 9: | merge(c, c.next) |
| 10: | break for loop |
| 11: | end if |
| 12: | end for |
| 13: | end while |
| 14: | if C.size < k then |
| 15: | split(C, k) // split clusters proportionally |
| 16: | end if |

In the above described approaches, the presented examples are for illustration purposes and may be tunable for particular practical cases. Additionally, the presented approaches are exemplary of possible approaches that may be used, but are not limiting, and other approaches may also be employed to profile cross-VM channel capacity using the principles described herein.

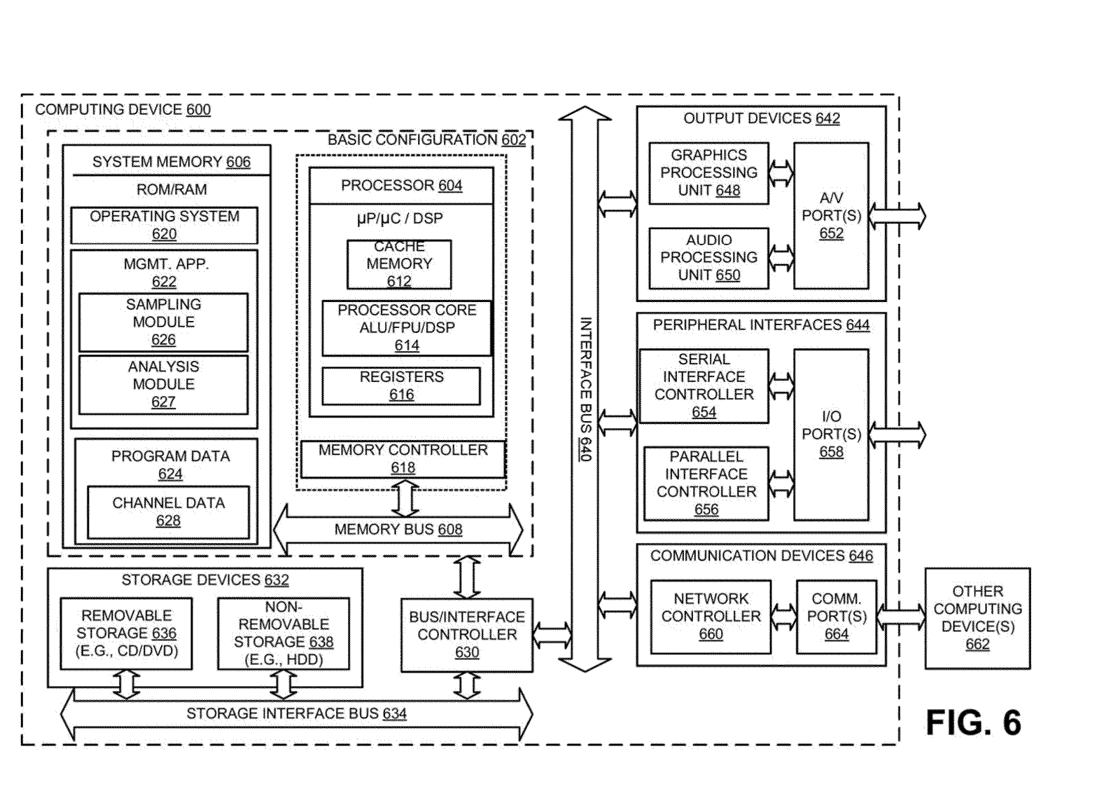

FIG. 6 illustrates a general purpose computing device, which may be used to provide an example automatic profiling framework for cross-VM covert channel capacity, arranged in accordance with at least some embodiments described herein.

For example, the computing device 600 may be a management or security server at a datacenter to implement automatic profiling for cross-VM covert channel capacity as described herein. In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, a processor core 614, and registers 616. The example processor core 614 may include an arithmetic logic unit (ALU), a floating point unit a digital signal processing core (DSP Core), or any combination thereof. An example memory controller 618 may also be used with the processor 604, or in some implementations the memory controller 618 may be an internal part of the processor 604.

Depending on the desired configuration, the system memory 606 may be of any type including but not limited to volatile memory (such as RAM), nonvolatile memory (such as ROM, flash memory, etc.) or any combination thereof. The system memory 606 may include an operating system 620, a management application 622, and program data 624, which may include channel data 628. The management application 622 may include a sampling module 626 and an analysis module 627 to profile cross-VM covert channel capacity as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable, storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk DVD) drives, solid state drives (SSDs), and tape drives to name a few. Example computer storage media may include volatile and nonvolatile, removable and no removable media implemented many method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology. CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices for example, keyboard, mouse, pen, voice input device, touch input device, etc.) or other peripheral devices (for example, printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

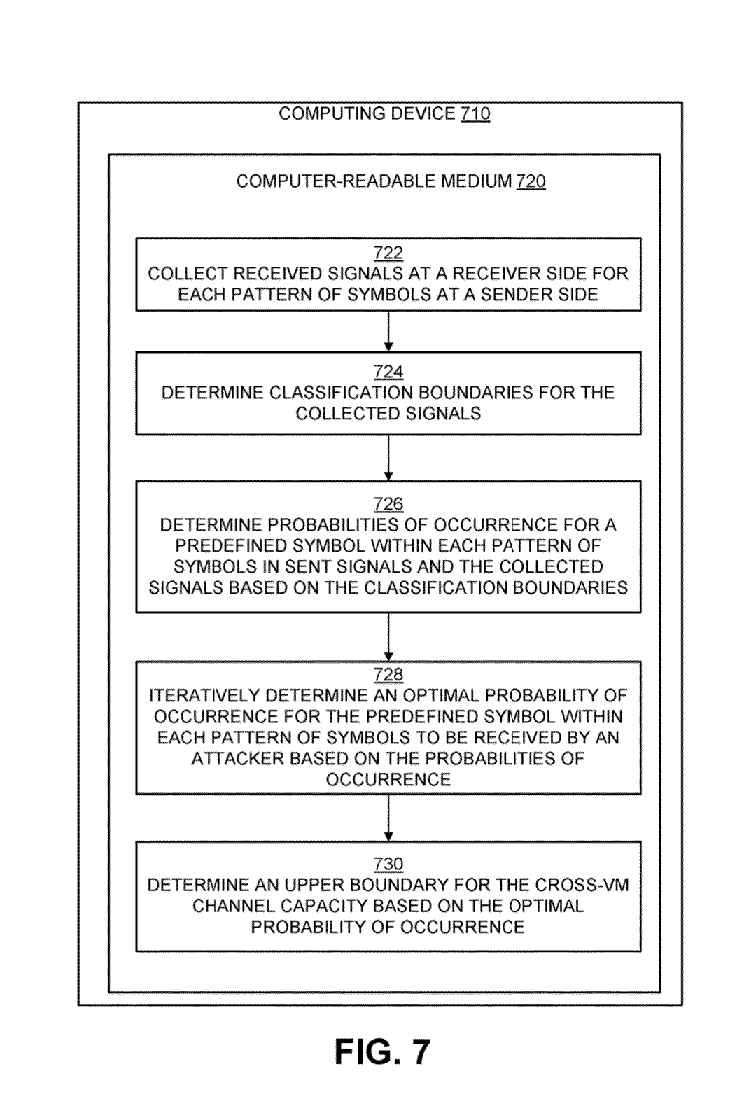

FIG. 7 is a flow diagram illustrating an example process to profile cross-VM covert channel capacity that may be performed by a computing device such as the computing device in FIG. 6, arranged in accordance with at least some embodiments described herein.

Example methods may include one or more operations, functions or actions as illustrated by one or more of blocks 722, 734, 726, 728, and/or 730, and may in some embodiments be performed by as computing device such as the computing device 600 in FIG. 6. The operations described in the blocks 722-730 may also be stored us computer-executable instructions in as computer-readable medium such as a computer-readable medium 720 of a computing device 710.

An example process to profile cross-VM covert channel capacity may begin with block 722, “COLLECT RECEIVED SIGNALS AT A RECEIVER SIDE FOR EACH PATTERN OF SYMBOLS AT A SENDER SIDE,”, where signals sent by a sender may be collected at the receiver side for each pattern of symbols. In order to simulate a real attack scenario and estimate as capacity of a covert channel, three entities may be defined within a cloud (or datacenter). A sender may represent the leaker and a receiver may represent the attacker as described herein. A controller may launch the co-residing VMs for the sender and the receiver, provide the instructions for transmission of signals, collection of the signals, and perform analysis. Thus, signals sent by the sender upon instructions from the controller may be collected at the receiver at block 722. Different patterns of symbols (“0” and “1” combinations) may be used and the signals may be sent/collected for each pattern of symbols. In some examples, a symbol alphabet may be generated by the controller and a sequence of binaries grouped as one compact symbol in order to make the symbol losses and insertions insignificant to the capacity estimation.

Block 722 may be followed by block 724, “DETERMINE CLASSIFICATION BOUNDARIES FOR COLLECTED SIGNALS,” where classification boundaries may be determined by the controller (which analyzes the collected signals) for the signals collected at the receiver side. Delimiters produced by the sender and frequently alternating between contention and idle to the contention sensitive operation may be used constrain the propagation of shifted boundaries due to channel noise.

Block 724 may be followed by block 726, “DETERMINE PROBABILITIES OF OCCURRENCE FOR A PREDEFINED SYMBOL WITHIN EACH PATTERN OF SYMBOLS IN SENT SIGNALS AND THE COLLECTED SIGNALS BASED ON THE CLASSIFICATION BOUNDARIES, where probabilities of occurrence for a predefined symbol within each pattern of symbols in sent signals and the collected signals may be determined by the controller based on the classification boundaries determined at block 724. A classifier may be determined for the signal samples with respect to their corresponding ground truth labels and used to classify the collected samples and produce the conditional probability, R(i|j).

Block 726 may be followed by block 728, “ITERATIVELY DETERMINE AN OPTIMAL PROBABILITY OF OCCURRENCE FOR THE PREDEFINED SYMBOL WITHIN EACH PATTERN OF SYMBOLS TO BE RECEIVED BY AN ATTACKER BASED ON THE PROBABILITIES OF OCCURRENCE,” where an iterative computation may be performed by the controller to determine an optimal probability of occurrence for the predefined symbol within each pattern of symbols to be received by an attacker based on the probabilities of occurrence. The iterative computation may include setting a value an initial probability of occurrence qⱼ for a symbol j in a pattern of symbols sent by a victim and then iterating until a vector difference between q^{t} and q^{t+1} is smaller than a predefined threshold.

Block 728 may be followed by block 730, “DETERMINE AN UPPER BOUNDARY FOR THE CROSS-VM CHANNEL CAPACITY BASED ON THE OPTIMAL PROBABILITY OF OCCURRENCE,” where an upper boundary for the cross-VM channel capacity may be determined based on the optimal probability of occurrence qⱼ using equation [1].

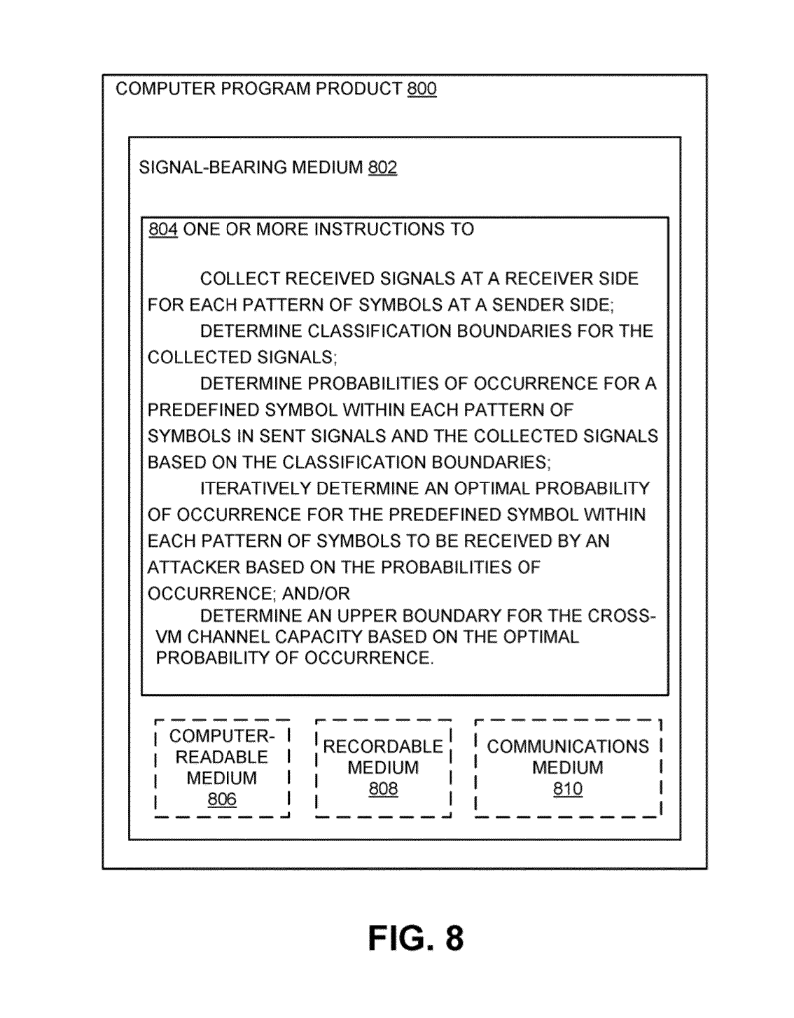

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, when executed by, for example, a processor may provide the functionality described herein. Thus, for example, referring to the processor 604 in FIG. 6, the management application 622 may undertake one or more of the tasks shown in FIG. 8 in response to the instructions 804 conveyed to the processor 604 by the medium 802 to perform actions associated with automatic profiling of cross-VM channel capacity as described herein. Some of those instructions may include, for example, instructions to collect received signals at a receiver side for each pattern of symbols at a sender side: determine classification boundaries for the collected signals; determine probabilities of occurrence for a predefined symbol within each pattern of symbols in sent signals and the collected signals based on the classification boundaries; iteratively determine an optimal probability occurrence for the predefined symbol within each pattern of symbols to be received by an attacker based on the probabilities of occurrence; and/or determine an upper boundary for the cross-VM Channel capacity based on the optimal probability of occurrence, according to some embodiments described herein.

In some implementations, the signal bearing media 802 depicted in FIG. 8 may encompass computer-readable media 806, such as, but not limited to, a hard disk drive, a solid state drive, a Compact Disk (CD), a Digital Versatile Disk (DVD), a digital tape, memory, etc. In some implementations, the signal bearing media 802 may encompass recordable media 810, such as, but not limited to, memory, read/write (R/W) CDs, R/W DVDs, etc. In some implementations, the signal bearing media 802 may encompass communications media 810, such as, but not limited to, a digital and/or an analog communication medium (for example, a fiber optic cable, a waveguide, a wired communications link, a wireless communication link, etc.). Thus, for example, the program product 800 may be conveyed to one or more modules of the processor 604 by an RF signal bearing medium, where the signal bearing media 802 is conveyed by the wireless communications media 810 (for example, a wireless communications medium conforming with the IEEE 802.11 standard).

According to some examples, methods to profile cross-VM covert channel capacity are described. An example method may include collecting received signals at a receiver side for each pattern of symbols at a sender side; determining classification boundaries for the collected signals; determining probabilities of occurrence for a predefined symbol within each pattern of symbols in sent signals and the collected signals based on the classification boundaries; iteratively determining an optimal probability of occurrence for the predefined symbol within each pattern of symbols to be received by an attacker based on the probabilities of occurrence; and determining an upper boundary for the cross-VM channel capacity based on the optimal probability of occurrence.

According to other examples, determining probabilities of occurrence for a predefined symbol within each pattern of symbols in sent signals and the collected signals may include computing a probability of occurrence pᵢ for a symbol i in a pattern of symbols received by the attacker, a probability of occurrence qⱼ for a symbol in a pattern of symbols sent by a victim, and a conditional probability R(i|j) that the attacker receives the symbol i when the victim transmits the symbol j. The method may further include determining the cross-VM: channel capacity based on:

$$𝒞 = B {max}_{{q}_{j} , j = 1 …N} ( Σ {q}_{j} R ( i \vert j ) log ( \frac{R ( i \vert j )}{{Σ}_{{j}^{′} , {j}^{′} = 1 …N} {q}_{{j}^{′}} R ( i \vert {j}^{′} )} ) ) ,$$

where B is an average number of symbols sent by the victim every second.

According to further examples, the victim and the attacker may be virtual machines (VMs) in a datacenter. The method may also include selecting the predefined symbols by sampling sent and received signals. The method may yet include grouping sampled sent and received signals based on a duration of transmission of one data bit and a sampling period and classifying the grouped sent and received signals to determine the R(i|j) using a machine learning classifier. The method may further include applying a cross-validation during the classification. The cross-validation may be a ten-fold cross-validation.

According to yet other examples, the method may also include for each symbol in an alphabet of symbols used by the sender, transmitting a predefined number of signals through a channel used by the sender, where a size of a delimiter for each signal is varied and generating a plurality of sample sets from the transmitted signals. Iteratively determining the optimal probability of occurrence may include iterating qⱼ as: qⱼ^{t+1}=exp(Σᵢ₌₁^{N}R(i|j)log(φ^{t} is defines as

$${ϕ}^{t} ( j \vert i ) = \frac{R ( i \vert j ) {q}_{j}^{t}}{{\sum }_{k = 1}^{N} R ( i \vert k ) {q}_{k}^{t}} .$$

The method may further include setting an initial optimal probability of occurrence, q₀, to be

$${q}_{j}^{0} = \frac{1}{N}$$

for i=1 . . . N; and iterating qᵢ until a difference between q^{t} and q^{t+1} is smaller than a predefined threshold.

According to other examples, a server configured to profile cross-VM covert channel capacity is described. The server may include a communication module configured to communicate with a plurality of virtual machines executed on one or more servers and a processor communicatively coupled to the communication module. The processor may be configured to collect received signals at a receiver side for each pattern of symbols at a sender side; determine classification boundaries for the collected signals; determine probabilities of occurrence for a predefined symbol within each pattern of symbols in sent signals and the collected signals based on the classification boundaries; iteratively determine an optimal probability of occurrence for the predefined symbol within each pattern of symbols to be received by an attacker based on the probabilities of occurrence; and determine an upper boundary for the cross-VM channel capacity based on the optimal probability of occurrence.

According to Some examples, the processor may be further configured to compute a probability of occurrence pᵢ for a symbol i in a pattern of symbols received by the attacker, a probability of occurrence qⱼ for a symbol j in a pattern of symbols sent by a victim, and a conditional probability R(i|j) that the attacker receives the symbol i when the victim transmits the symbol j; and determine the cross-VM channel capacity based on:

$$𝒞 = B {max}_{{q}_{j} , j = 1 …N} ( Σ {q}_{j} R ( i \vert j ) log ( \frac{R ( i \vert j )}{{Σ}_{{j}^{′} , {j}^{′} = 1 …N} {q}_{{j}^{′}} R ( i \vert {j}^{′} )} ) ) ,$$

where B is an average number of symbols sent by the victim every second. The victim may he a virtual machine (VM) configured to send the signals and the attacker may be another VM configured to receive the signals. The victim and the attacker may be co-resident VMs.

According to yet other examples, the processor may be further configured to for each symbol in an alphabet of symbols used by the sender, transmit a predefined number of signals through a channel used by the sender, where a size of at least one of a start delimiter and an end delimiter for each signal is varied; generate a plurality of sample sets from the transmitted signals; group the plurality of sample sets based on a duration of transmission of one data bit and a sampling period; and classify the grouped sample sets to determine the R(i|j) using a machine learning classifier. The processor may also be configured to set an initial optimal probability of occurrence, q₀, to be

$${q}_{j}^{0} = \frac{1}{N}$$

for j=1 . . . N; and iterate qᵢ until a difference between q^{t} and q^{t+1} is smaller than a predefined threshold as: qⱼ^{t+1}=exp(Σᵢ₌₁^{N}R(i|j)log(φ_{j|i}^{t})), where φ^{t} is defined as

$${ϕ}^{t} ( j \vert i ) = \frac{R ( i \vert j ) {q}_{j}^{t}}{{\sum }_{k = 1}^{N} R ( i \vert k ) {q}_{k}^{t}} .$$

The cross-VM covert channel capacity may be associated with a central processing unit (CPU) load, a CPU L2 cache, a memory bus, or a disk bus. The plurality of virtual machines executed on one or more servers may be in distinct datacenters.

According to further examples, methods to profile cross-VM covert channel capacity are described. An example method may include modelling a noise level of a cross-VM covert channel between two co-resident virtual machines (VMs) established in a cloud platform; generating sample signals employing one or more distinct timing parameter settings of the cross-VM covert channel; modifying the generated sample signals by adding noise based on the modelled noise level; arranging for the modified sample signals to be transmitted by one of the co-resident VMs and collected by the other of the co-resident VMs; analyzing the collected sample signals by iteratively determining an optimal probability of occurrence for a predefined symbol within each sample signal; and determining an upper boundary for the cross-VM channel capacity based on the optimal probability of occurrence.

According to other examples, the timing parameter settings may include one or more of a threshold t₀ to distinguish between high and low signals, an interval dₛ for sending one data bit from the sender, and at sampling period dₛ. The method may also include grouping the collected sample signals based on t₀, dₛ, and dᵣ; classifying the grouped sample signals to determine as conditional probability R(i|j) that the attacker receives a symbol i when the victim transmits a symbol j using a machine learning classifier. Iteratively determining the optimal probability of occurrence may include setting an initial optimal probability of occurrence, q₀, to be

$${q}_{j}^{0} = \frac{1}{N}$$

for) j=1 . . . N; and iterating qᵢ until a difference between q^{t} and q^{t+1} is smaller than a predefined threshold as qⱼ^{t+1}=exp(93 ᵢ₌₁^{N}R(i|j)log(φ_{j|i}^{t})), where φ^{t} is defined as

$${ϕ}^{t} ( j \vert i ) = \frac{R ( i \vert j ) {q}_{j}^{t}}{{\sum }_{k = 1}^{N} R ( i \vert k ) {q}_{k}^{t}} .$$

Various embodiments may be implemented in hardware, software, or combination of both hardware and software (or other computer-readable instructions stored on a non-transitory computer-readable storage medium and executable by one or more processors); the use of hardware of software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, anchor examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (for example, as one or more programs executing on one or more computer systems), as one or more programs executing on one or more processors thy example, as one or more programs executing on one or more microprocessors), as firmware, or as virtually any combination thereof, and designing the circuitry and/or writing the code for the software and or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. Also, the terminology used herein is for the purpose of describing particular embodiments only, and is not intended to be limiting.

In addition, the mechanisms of the subject mutter described herein are capable of being distributed as a program product in a variety of forms, and that an illustrative embodiment of the subject matter described herein applies regardless of the particular type of signal bearing medium used to actually carry out the distribution: Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (for example, feedback for sensing position and/or velocity of gantry systems; control motors to move and/or adjust components and/or quantities).

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,”etc.). It will be further understood by those within the art that, if as specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not he construed to imply that the introduction of a claim recitation by the indefinite articles “a” of “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C. etc,” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” of “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being, broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to profile cross-VM covert channel capacity, the method comprising:
collecting received signals at a receiver side for each pattern of symbols at a sender side;
determining classification boundaries for the collected signals;
determining probabilities of occurrence for a predefined symbol within each pattern of symbols in sent signals and the collected signals based on the classification boundaries;
iteratively determining an optimal probability of occurrence for the predefined symbol within each pattern of symbols to be received by an attacker based on the probabilities of occurrence: and
determining an upper boundary for the cross-VM channel capacity based on the optimal probability of occurrence.

2. The method of claim 1, wherein determining probabilities of occurrence for a predefined symbol within each pattern of symbols in sent signals and the collected signals comprises:
computing a probability of occurrence pᵢ for a symbol i in a pattern of symbols received by the attacker, a probability of occurrence qⱼ for a symbol j in a pattern of symbols sent by a victim, and a conditional probability R(i|j) that the attacker receives the symbol i when the victim transmits the symbol j.

3. The method of claim 2, further comprising:
determining the cross-VM channel capacity based on:
$$𝒞 = B {max}_{{q}_{j} , j = 1 …N} ( Σ {q}_{j} R ( i \vert j ) log ( \frac{R ( i \vert j )}{{Σ}_{{j}^{′} , {j}^{′} = 1 …N} {q}_{{j}^{′}} R ( i \vert {j}^{′} )} ) ) ,$$
wherein B is an average number of symbols sent by the victim every second.

4. (canceled)

5. The method of claim 2, further comprising:
selecting the predefined symbols by sampling sent and received signals.

6. The method of claim 5, further comprising:
grouping sampled sent and received signals based on a duration of transmission of one data bit and a sampling period; and
classifying the grouped sent and received signals to determine the R(i|j) using a machine learning classifier.

7. The method of claim 6, further comprising:
applying a cross-validation during the classification.

8. (cancelled)

9. The method of claim 1, further comprising:
for each symbol in an alphabet of symbols used by the sender, transmitting a predefined number of signals through a channel used by the sender, wherein a size of a delimiter for each signal is varied; and
generating a plurality of sample sets from the transmitted signals.

10. The method of claim 1, wherein iteratively determining the optimal probability of occurrence comprises:
iterating qⱼ as:
qⱼ^{t+1}=exp(Σᵢ₌₁^{N}R(i|j)log(φ_{j|i}^{t})), where φ^{t} is defined as
$${ϕ}^{t} ( j \vert i ) = \frac{R ( i \vert j ) {q}_{j}^{t}}{{\sum }_{k = 1}^{N} R ( i \vert k ) {q}_{k}^{t}} .$$

11. The method of claim 10, further comprising:
setting an initial optimal probability of occurrence, g₀, to be
$${q}_{j}^{0} = \frac{1}{N}$$
for j=1 . . . N; and
iterating qᵢ until a difference between q^{t} and q^{t+1} is smaller than a predefined threshold.

12. A server configured to profile cross-VM covert channel capacity, the server comprising:
a communication module configured to communicate with a plurality of virtual machines executed on one or more servers;
a processor communicatively coupled to the communication module, the processor configured to:
collect received signals at a receiver side for each pattern of symbols at a sender side;
determine classification boundaries for the collected signals:
determine probabilities of occurrence for a predefined symbol within each pattern of symbols in sent signals and the collected signals based on the classification boundaries;
iteratively determine an optimal probability of occurrence for the predefined symbol within each pattern of symbols to be received by an attacker based on the probabilities of occurrence; and
determine an upper boundary for the cross-VM channel capacity based on the optimal probability of occurrence.

13. The server of claim 12, wherein the processor is further configured to:
compute a probability of occurrence pᵢ for a symbol i in a pattern of symbols received by the attacker, a probability of occurrence qⱼ for a symbol j in a pattern of symbols sent by a victim, and a conditional probability R(i|j) that the attacker receives the symbol i when the victim transmits the symbol j; and
determine the cross-VM channel capacity based on:
$$𝒞 = B {max}_{{q}_{j} , j = 1 …N} ( Σ {q}_{j} R ( i \vert j ) log ( \frac{R ( i \vert j )}{{Σ}_{{j}^{′} , {j}^{′} = 1 …N} {q}_{{j}^{′}} R ( i \vert {j}^{′} )} ) ) ,$$
wherein B is an average number of symbols sent by the victim every second.

14. The server of claim 13, wherein the victim is as virtual machine (VM) configured to send the signals and the attacker is another VM configured to receive the signals.

15. (canceled)

16. The server of claim 12, wherein the processor is further configured to:
for each symbol in an alphabet of symbols used by the sender, transmit a predefined number of signals through a channel used by the sender, wherein a size of at least one of a start delimiter and an end delimiter for each signal is varied;
generate a plurality of sample sets from the transmitted signals;
group the plurality of sample sets based on a duration of transmission of one data bit and as sampling period; and
classify the grouped sample sets to determine the R(i|j) using a machine learning classifier.

17. The server of claim 12, wherein the processor is further configured to:
set an initial optimal probability of occurrence, q₀, to be
$${q}_{j}^{0} = \frac{1}{N}$$
for j=1 . . . N; and
iterate qᵢ until a difference between q^{t} and q^{t+1} is smaller than a predefined threshold as:
qⱼ^{t+1}=exp(Σᵢ₌₁^{N}R(i|j)log(φ_{j|i}^{t})), where φ^{t} is defined as
$${ϕ}^{t} ( j \vert i ) = \frac{R ( i \vert j ) {q}_{j}^{t}}{{\sum }_{k = 1}^{N} R ( i \vert k ) {q}_{k}^{t}} .$$

18. The server of claim 12, wherein the cross-VM covert channel capacity is associated with one of: a central processing, unit (CPU) load, a CPU L2 cache, as memory bus, and a disk bus.

19. The server of claim 12, wherein the plurality of virtual machines executed on one or more servers are in distinct datacenters.

20. A method to profile cross-VM covert channel capacity, the method comprising:
modelling a noise level of a cross-VM covert channel between two co-resident virtual machines (VMs) established in a cloud platform;
generating sample signals employing one or more distinct timing parameter settings of the cross-VM covert channel;
modifying the generated sample signals by adding noise based on the modelled noise level;
arranging for the modified sample signals to be transmitted by one of the co-resident VMs and collected by the other of the co-resident VMs;
analyzing the collected sample signals by iteratively determining an optimal probability of occurrence for a predefined symbol within each sample signal; and
determining an upper boundary for the cross-VM channel capacity based on the optimal probability of occurrence.

21. The method of claim 20, wherein the timing parameter settings include one or more of a threshold t₀ to distinguish between high and low signals, an interval dₛ for sending one data bit from the sender, and a sampling period d₅.

22. The method of claim 21, further comprising:
grouping the collected sample signals based on t₀, dₛ, and dᵣ; and
classifying the grouped sample signals to determine a conditional probability R(i|j) that the attacker receives as symbol i when the victim transmits a symbol j using a machine learning classifier.

23. The method of claim 20, wherein iteratively determining the optimal probability of occurrence comprises:
setting an initial optimal probability of occurrence, q₀, to be
$${q}_{j}^{0} = \frac{1}{N}$$
for j=1 . . . N; and
iterating qᵢ until as difference between q^{t} and q^{t+1} is smaller than a predefined threshold as:
qⱼ^{t+1}=exp(Σᵢ₌₁^{N}R(i|j)log(φ_{j|i}^{t}), where φ^{t} is defined as
$${ϕ}^{t} ( j \vert i ) = \frac{R ( i \vert j ) {q}_{j}^{t}}{{\sum }_{k = 1}^{N} R ( i \vert k ) {q}_{k}^{t}} .$$
